(19) United States
(12) Patent Application Publication
(10) Pub. No.: US 2024/0412312 A1
(43) Pub. Date: Dec. 12, 2024

(54) NEGOTIATION DEVICE, NEGOTIATION METHOD, AND NEGOTIATION PROGRAM

(71) Applicant: NEC Corporation, Minato-ku, Tokyo (JP)

(72) Inventors: Tomohito ANDO, Tokyo (JP); Satoshi MORINAGA, Tokyo (JP)

(73) Assignee: NEC Corporation, Minato-ku, Tokyo (JP)

(21) Appl. No.: 18/697,503

(22) PCT Filed: Oct. 7, 2021
(86) PCT No.: PCT/JP2021/037118

§ 371 Date: Apr. 1, 2024

(51) Int. Cl. G06Q 50/18

(52) U.S. Cl. CPC G06Q 50/188

(57) ABSTRACT

To further reduce the number of times draft agreement candidates are provided until a consensus forms, a negotiation apparatus includes a disclosed negotiation strategy provision section that provides a first disclosed negotiation strategy that is a disclosed negotiation strategy of a first negotiation entity and that includes a first utility function or a parameter set defining the first utility function.

### TECHNICAL FIELD

The present invention relates to a negotiation apparatus, a negotiation method, and a negotiation program, for use in negotiation carried out on the basis of negotiation strategies.

### BACKGROUND ART

A technique for automatically carrying out, with use of computers, various types of negotiation, which have been carried out by humans so far, has been developed. For example, Patent Literature 1 discloses a technique for carrying out negotiation that has been carried out between an orderer and a contractor so far, automatically between an orderer-side negotiation apparatus and a contractor-side negotiation apparatus.

### CITATION LIST

### Patent Literature

### [Patent Literature 1]

International Publication No. WO 2021/033302

### SUMMARY OF INVENTION

### Technical Problem

The contractor-side negotiation apparatus disclosed in Patent Literature 1 includes: a contractor-side utility calculation section that calculates a value of utility brought to the contractor in connection with a negotiation candidate; and an orderer-side utility estimation section that estimates a value of utility brought to the orderer in connection with the negotiation candidate. Then, the contractor-side negotiation apparatus disclosed in Patent Literature 1 selects, from among a plurality of the negotiation candidates, a negotiation candidate to be provided to the orderer, based on the value of utility brought to the contractor and the value of utility brought to the orderer, to reduce the number of negotiations. However, the value of utility brought to the orderer, which is referred to to select a negotiation candidate to be provided to the orderer, is merely an estimate. Thus, if the estimation accuracy of the value of utility brought to the orderer is low, it is difficult to sufficiently reduce the number of negotiations.

An example aspect of the present invention has been made in view of the this problem, and an example object thereof is to provide a technique capable of further reducing the number of times draft agreement candidates are provided until a consensus forms.

### Solution to Problem

A negotiation apparatus in accordance with an example aspect of the present invention is a negotiation apparatus that includes disclosed negotiation strategy provision means for providing a first disclosed negotiation strategy that is a disclosed negotiation strategy of a first negotiation entity and that includes a first utility function or a parameter set defining the first utility function.

The negotiation apparatus in accordance with an example aspect of the present invention further includes: disclosed negotiation strategy obtaining means for obtaining a second disclosed negotiation strategy that is a disclosed negotiation strategy of a second negotiation entity and that includes a second utility function or a parameter set defining the second utility function; and negotiation execution means for referring to the first disclosed negotiation strategy and the second disclosed negotiation strategy, to select a draft agreement candidate to be provided to the second negotiation entity.

In the negotiation apparatus in accordance with an example aspect of the present invention, the negotiation execution means (1) refers to the first disclosed negotiation strategy and the second disclosed negotiation strategy, to select one or more draft agreement candidates each agreeable to both the first negotiation entity and the second negotiation entity, and (2) refers to the one or more selected draft agreement candidates, to select a draft agreement candidate to be provided to the second negotiation entity.

In the negotiation apparatus in accordance with an example aspect of the present invention, the negotiation execution means (1) refers to the first disclosed negotiation strategy and the second disclosed negotiation strategy, to select a draft agreement candidate that maximizes a sum total of utilities brought to the first negotiation entity and the second negotiation entity, and (2) refers to the selected draft agreement candidate, to select a draft agreement candidate to be provided to the second negotiation entity.

The negotiation apparatus in accordance with an example aspect of the present invention further includes negotiation strategy setting means for setting the first disclosed negotiation strategy in accordance with a user operation.

The negotiation apparatus in accordance with an example aspect of the present invention further includes: disclosed negotiation strategy obtaining means for obtaining a second disclosed negotiation strategy that is a disclosed negotiation strategy of a second negotiation entity and that includes a second utility function or a parameter set defining the second utility function; and negotiation execution means for referring to an undisclosed negotiation strategy that is an undisclosed negotiation strategy of the first negotiation entity and that includes a third utility function or a parameter set defining the third utility function and to the second disclosed negotiation strategy, to select a draft agreement candidate to be provided to the second negotiation entity.

In the negotiation apparatus in accordance with an example aspect of the present invention, the negotiation execution means (1) refers to the undisclosed negotiation strategy and the second disclosed negotiation strategy, to select one or more draft agreement candidates each agreeable to both the first negotiation entity and the second negotiation entity, and (2) refers to the one or more selected draft agreement candidates, to select a draft agreement candidate to be provided to the second negotiation entity.

In the negotiation apparatus in accordance with an example aspect of the present invention, the negotiation execution means (1) refers to the undisclosed negotiation strategy and the second disclosed negotiation strategy, to select a draft agreement candidate that maximizes a sum total of utilities brought to the first negotiation entity and the second negotiation entity, and (2) refers to the selected draft agreement candidate, to select a draft agreement candidate to be provided to the second negotiation entity.

The negotiation apparatus in accordance with an example aspect of the present invention further includes negotiation strategy setting means for setting, in accordance with a user operation, one of the first disclosed negotiation strategy and the undisclosed negotiation strategy, or each of the first disclosed negotiation strategy and the undisclosed negotiation strategy.

The negotiation apparatus in accordance with an example aspect of the present invention further includes disclosure range setting means for setting a disclosure range of the first disclosed negotiation strategy in accordance with a user operation.

A negotiation method in accordance with an example aspect of the present invention includes providing, by a computer, a first disclosed negotiation strategy that is a disclosed negotiation strategy of a first negotiation entity and that includes a first utility function or a parameter set defining the first utility function.

A negotiation program in accordance with an example aspect of the present invention causes a computer to function as disclosed negotiation strategy provision means for providing a first disclosed negotiation strategy that is a disclosed negotiation strategy of a first negotiation entity and that includes a first utility function or a parameter set defining the first utility function.

### Advantageous Effects of Invention

According to an example aspect of the present invention, it is possible to reduce the number of times draft agreement candidates are provided until a consensus forms.

### BRIEF DESCRIPTION OF DRAWINGS

FIG. 1 is a block diagram illustrating the configuration of a negotiation apparatus in accordance with a first example embodiment of the present invention.

FIG. 2 is a sequence chart illustrating the flow of the operation of the negotiation apparatus illustrated in FIG. 1.

FIG. 3 is a block diagram illustrating the configuration of a negotiation apparatus in accordance with a second example embodiment of the present invention.

FIG. 4 is a sequence chart illustrating the flow of the operation of the negotiation apparatus illustrated in FIG. 3.

FIG. 5 is a block diagram illustrating the configuration of a negotiation apparatus in accordance with a third example embodiment of the present invention.

FIG. 6 is a sequence chart illustrating the flow of the operation of the negotiation apparatus illustrated in FIG. 5.

FIG. 7 is a block diagram illustrating the configuration of a negotiation system in accordance with a fourth example embodiment of the present invention.

FIG. 8 is a block diagram illustrating the hardware configuration of a computer that functions as each of the negotiation apparatuses in accordance with the example embodiments of the present invention.

### EXAMPLE EMBODIMENTS

As used herein, the term “negotiation entity” refers to, for example, an entity having an ability to select a draft agreement candidate to be provided to another negotiation entity and having an ability to determine whether or not to agree to a draft agreement candidate obtained from another negotiation entity. The negotiation entity may be an apparatus, may be a human, or may be an organization. The term “negotiation apparatus” refers to, for example, an apparatus that functions as a negotiation entity. Examples of the negotiation apparatus may include a computer, a robot, a drone, an automated driving vehicle, and the like. The term “negotiation” refers to, for example, proceedings in which negotiation entities alternately provide a draft agreement candidate until the negotiation entities reach an agreement. The negotiation may be negotiation between entities in conflict of interest or negotiation (adjustment) between entities not in conflict of interest.

In the following description, it is assumed that negotiation is carried out between two parties, that is, a first negotiation entity and a second negotiation entity that share a set Q of draft agreement candidates. Note that this assumption is for convenience of explanation, and even multiparty negotiation by three or more negotiation entities is included in the scope of the present invention. By way of example only, and without limitation, the draft agreement candidate ω∈Ω is an array (ω₁, ω₂, ω₃, ω₄) having four elements: a product number ω₁, a product quantity ω₂, a product price ω₃, and a delivery date ω₄.

### First Example Embodiment

The following description will discuss a first example embodiment of the present invention with reference to the drawings. The present example embodiment is a basic form of each example embodiment described later.

(Configuration of negotiation apparatus)

The following description will discuss the configuration of a negotiation apparatus 1 in accordance with the present example embodiment with reference to FIG. 1. FIG. 1 is a block diagram illustrating the configuration of the negotiation apparatus 1.

The negotiation apparatus 1 includes a disclosed negotiation strategy provision section 11, as illustrated in FIG. 1.

The disclosed negotiation strategy provision section 11 is means for providing a first disclosed negotiation strategy PS1. The first disclosed negotiation strategy PS1 is a disclosed negotiation strategy of a first negotiation entity and includes a first utility function f1 or a parameter set defining the first utility function f1. For example, a second negotiation entity is assumed to be provided with the first disclosed negotiation strategy PS1. The second negotiation entity may be a human or an apparatus.

The first utility function f1 is assumed to be, for example, the function f1: Ω→R in which a set Ω of draft agreement candidates is used as a domain and a set R of real numbers is used as a range. In this case, utility value f1(ω) in connection with each draft agreement candidate ω represents, for example, a utility or benefit brought to the first negotiation entity when a consensus forms with the draft agreement candidate w. For a draft agreement candidate ω obtained from the second negotiation entity, the first negotiation entity agrees to the draft agreement candidate ω when the utility value f1(ω) exceeds a predetermined threshold α1, for example. For a draft agreement candidate ω to be provided to the second negotiation entity, the first negotiation entity selects the draft agreement candidate ω when the utility value f1(ω) exceeds a predetermined threshold β1 (which may be β1=α1), for example. The first utility function f1 can be, for example, a trained model that receives a draft agreement candidate ω as input and outputs the utility value f1(ω), that is, an artificial intelligence (AI). Alternatively, a table that associates a draft agreement candidate ω and the utility value f1(ω) may be used as the first utility function f1. Note that the first disclosed negotiation strategy PS1 may include one or both of the threshold α1 and the threshold B1, in addition to the first utility function f1 or the parameter defining the first utility function f1.

### (Operation of Negotiation Apparatus)

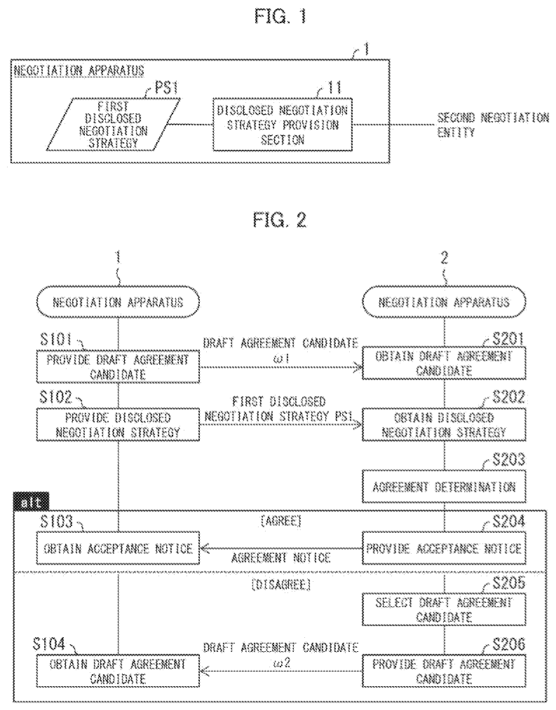

The following description will discuss the operation of the negotiation apparatus 1 with reference to FIG. 2. FIG. 2 is a sequence chart illustrating the flow of the operation of the negotiation apparatus 1. Here, it is assumed that a negotiation apparatus 2 is the second negotiation entity.

First, in step S101, the negotiation apparatus 1 provides a draft agreement candidate ω1∈Ω to the negotiation apparatus 2. In step S201, the negotiation apparatus 2 receives the draft agreement candidate ω1 from the negotiation apparatus 1.

Next, in step S102, the negotiation apparatus 1 provides a first disclosed negotiation strategy PS1 to the negotiation apparatus 2. In step S202, the negotiation apparatus 2 receives the first disclosed negotiation strategy PS1 from the negotiation apparatus 1. The steps S102 and S202 may be implemented upon request of the negotiation apparatus 2 issued to the negotiation apparatus 1.

Next, in step S203, the negotiation apparatus 2 determines whether or not to agree to the draft agreement candidate ω1. When determining to “agree” in step S203, the negotiation apparatus 2 provides an agreement notice to the negotiation apparatus 1 in step S204, and the negotiation apparatus 1 receives the agreement notice from the negotiation apparatus 2 in step S103. Thus, a consensus forms and the negotiation ends.

When determining to “disagree” in step S203, the negotiation apparatus 2 selects a new draft agreement candidate ω2∈Ω in step S205. At this time, the negotiation apparatus 2 can refer to the first disclosed negotiation strategy PS1 to select the new draft agreement candidate ω2.

Next, in step S206, the negotiation apparatus 2 provides the new draft agreement candidate ω2 to the negotiation apparatus 1. In step S104, the negotiation apparatus 1 receives the new draft agreement candidate ω2 from the negotiation apparatus 2. When the draft agreement candidate ω1 is referred to as an “offer”, the new draft agreement candidate ω2 may also be referred to as a “counter-offer”.

### Example Advantage of Negotiation Apparatus

The present example embodiment enables the second negotiation entity (negotiation apparatus 2) to determine the draft agreement candidate ω2 to be provided to the first negotiation entity (negotiation apparatus 1) with reference to the first disclosed negotiation strategy PS1. This enables the second negotiation entity (negotiation apparatus 2) to provide the first negotiation entity (negotiation apparatus 1) with the draft agreement candidate ω2 having a high probability that the first negotiation entity (negotiation apparatus 1) agrees. Therefore, it is possible to reduce the number of times the draft agreement candidate ω2 is provided until a consensus forms.

Therefore, in the setting in which negotiation continues until a consensus forms, it is possible to shorten the time until the consensus forms. Further, in the setting in which negotiation is terminated when a consensus does not form within a predetermined time, the probability that no consensus forms can be reduced. In addition, in the settings in which a forced agreement is made with the last draft agreement candidate provided when no consensus forms within a predetermined time, it is possible to reduce the probability that it is forced to reach an agreement before the utility value increases to a sufficiently high value.

### Second Example Embodiment

The following description will discuss a second example embodiment of the present invention with reference to the drawings. The same reference numerals are given to constituent elements which have functions identical to those described in the first example embodiment, and descriptions as to such constituent elements are omitted.

### (Configuration of Negotiation Apparatus)

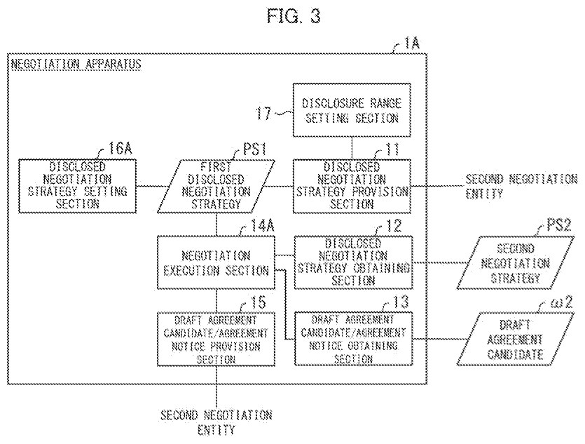

The following description will discuss the configuration of a negotiation apparatus 1A in accordance with the present example embodiment with reference to FIG. 3. FIG. 3 is a block diagram illustrating the configuration of the negotiation apparatus 1A.

As illustrated in FIG. 3, the negotiation apparatus 1A includes: a disclosed negotiation strategy provision section 11; a disclosed negotiation strategy obtaining section 12; a draft agreement candidate/agreement notice obtaining section 13; a negotiation execution section 14A; and a draft agreement candidate/agreement notice provision section 15.

The disclosed negotiation strategy provision section 11 is means for providing a first disclosed negotiation strategy PS1, similarly to the disclosed negotiation strategy provision section 11 included in the negotiation apparatus 1.

The disclosed negotiation strategy obtaining section 12 is means for obtaining a second disclosed negotiation strategy PS2. The second disclosed negotiation strategy PS2 is a disclosed negotiation strategy of the second negotiation entity and includes a second utility function f2 or a parameter set defining the second utility function f2. For example, it is assumed that the second disclosed negotiation strategy PS2 is received from the second negotiation entity.

The second utility function f2 is assumed to be, for example, the function f2:Ω→R in which a set Ω of draft agreement candidates is used as a domain and a set R of real numbers is used as a range. In this case, utility value f2(ω) in connection with each draft agreement candidate ω represents, for example, a utility or benefit brought to the second negotiation entity when a consensus forms with the draft agreement candidate ω. For a draft agreement candidate ω obtained from the first negotiation entity, the second negotiation entity agrees to the draft agreement candidate ω when the utility value f2(ω) exceeds a predetermined threshold α2, for example. For a draft agreement candidate ω to be provided to the first negotiation entity, the second negotiation entity selects the draft agreement candidate ω when the utility value f2(ω) exceeds a predetermined threshold β2 (which may be β2=α2), for example. The second utility function f2 can be, for example, a trained model that receives a draft agreement candidate ω as input and outputs the utility value f2(ω), that is, an AI. Alternatively, a table that associates a draft agreement candidate ω and the utility value f2(ω) may be used as the second utility function f2. Note that the second disclosed negotiation strategy PS2 may include one or both of the threshold α2 and the threshold β2, in addition to the second utility function f2 or the parameter defining the second utility function f2.

The draft agreement candidate/agreement notice obtaining section 13 is means for obtaining a draft agreement candidate ω2 or an agreement notice. For example, it is assumed that the draft agreement candidate ω2 and the agreement notice are received from the second negotiation entity.

The negotiation execution section 14A is means for (1) determining, with reference to the first disclosed negotiation strategy PS1, as to whether or not to agree to the draft agreement candidate ω2; and then (2) when it is determined to “disagree” to the draft agreement candidate ω2, selecting a new draft agreement candidate ω1 with reference to the first disclosed publication strategy PS1 and the second disclosed negotiation strategy PS2. The negotiation execution section 14A may refer to the second disclosed negotiation strategy PS2 in addition to the first disclosed negotiation strategy PS1 in determining whether or not to agree to the draft agreement candidate ω2. In addition, when a plurality of negotiation strategies are available as the first disclosed negotiation strategy PS1, the negotiation execution section 14A may be configured to switch the negotiation strategy referred to as the first disclosed negotiation strategy PS1 in the above determination and selection, in accordance with the draft agreement candidate ω2. For example, depending on whether or not the draft agreement candidate ω2 is highly likely to receive an order, it is conceivable to switch a negotiation strategy referred to as the first disclosed negotiation strategy PS1 in the abovementioned determination and selection.

The draft agreement candidate/agreement notice provision section 15 is means for providing a draft agreement candidate ω2 or an agreement notice. When the negotiation execution section 14A determines to “disagree” to the draft agreement candidate the ω2, draft agreement candidate/agreement notice provision section 15 provides a new draft agreement candidate ω1 selected by the negotiation execution section 14A. When the negotiation execution section 14A determines to “agree” to the draft agreement candidate ω2, the draft agreement candidate/agreement notice provision section 15 provides an agreement notice. For example, the second negotiation entity is assumed to be provided with the draft agreement candidate ω1 and the agreement notice.

The negotiation apparatus 1A may further include a negotiation strategy setting section 16A. The negotiation strategy setting section 16A is means for setting the first disclosed negotiation strategy PS1 in accordance with a user operation. When the negotiation apparatus 1A further includes the negotiation strategy setting section 16A, the user of the negotiation apparatus 1A (the first negotiation entity) can freely set the first disclosed negotiation strategy PS1.

The negotiation apparatus 1A may further include a disclosure range setting section 17. The disclosure range setting section 17 is means for setting the disclosure range of the first disclosed negotiation strategy PS1 in accordance with a user operation. The disclosure range setting section 17 may set the disclosure range by listing negotiation entities that are permitted to obtain the first disclosed negotiation strategy PS1, or alternatively, may set the disclosure range by listing negotiation entities that are not permitted to obtain the first disclosed negotiation strategy PS1. Further, one or both of these lists may be added to the first disclosed negotiation strategy PS1 as a flag or flags. When the negotiation apparatus 1A further includes the disclosure range setting section 17, the user of the negotiation apparatus 1A (the first negotiation entity) can freely set the disclosure range of the first disclosed negotiation strategy PS1.

### (Operation of Negotiation Apparatus)

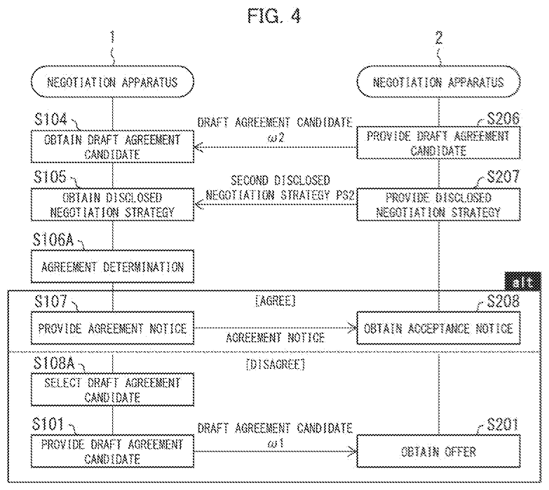

The following description will discuss the operation of the negotiation apparatus 1A with reference to FIG. 4. FIG. 4 is a sequence chart illustrating the flow of the operation of the negotiation apparatus 1A. The negotiation apparatus 1A repeats the operation illustrated in FIG. 2 and the operation illustrated in FIG. 4 until an agreement is reached with the negotiation apparatus 2. Step S104 and step S206 in FIG. 4 correspond to step S104 and step S206 in FIG. 2, respectively. Step S101 and step S201 in FIG. 4 correspond to step S101 and step S201 in FIG. 2, respectively.

First, in step S206, the negotiation apparatus 2 provides a draft agreement candidate ω2∈Ω to the negotiation apparatus 1A. In step S104, the negotiation apparatus 1A receives the draft agreement candidate ω2 from the negotiation apparatus 2.

Next, in step S207, the negotiation apparatus 2 provides a second disclosed negotiation strategy PS2 to the negotiation apparatus 1A. In step S105, the negotiation apparatus 1A receives the second disclosed negotiation strategy PS2 from the negotiation apparatus 2. The steps S105 and S207 may be implemented upon request of the negotiation apparatus 1A issued to the negotiation apparatus 2.

Next, in step S106A, the negotiation apparatus 1A determines whether or not to agree to the draft agreement candidate ω2. At this time, the negotiation apparatus 1A refers to the first disclosed negotiation strategy PS1 to determine whether or not to agree to the draft agreement candidate ω2.

For example, in step S106A, the negotiation execution section 14A determines whether or not to agree to the draft agreement candidate ω2 as follows. First, the negotiation execution section 14A calculates the utility value f1(ω2) of the draft agreement candidate ω2, using the first utility function f1 included in the first disclosed negotiation strategy PS1. Next, the negotiation execution section 14A compares the utility value f1(ω2) of the draft agreement candidate ω2 with the threshold α1. Then, the negotiation execution section 14A determines to “agree” to the draft agreement candidate ω2 when the utility value f1(ω2) of the draft agreement candidate ω2 exceeds the threshold α1, and otherwise, the negotiation execution section 14A determines to “disagree” to the draft agreement candidate ω2.

The negotiation execution section 14A may compare the utility value f1(ω2) of the draft agreement candidate ω2 with the utility value f1(ω1) of the draft agreement candidate ω1 scheduled to be provided to the second negotiation entity next, instead of comparing with the threshold α1. In this case, the negotiation execution section 14A determines to “agree” to the draft agreement candidate ω2 when the utility value f1(ω2) of the draft agreement candidate ω2 exceeds the utility value f1(ω1), and otherwise, the negotiation execution section 14A determines to “disagree” to the draft agreement candidate ω2.

The negotiation execution section 14A may refer to the second disclosed negotiation strategy PS2 in addition to the first disclosed negotiation strategy PS1 to determine whether or not to agree to the draft agreement candidate ω2. This enables the negotiation execution section 14A to calculate the utility value f2(ω2) of the draft agreement candidate ω2, using the second utility function f2 included in the second negotiation strategy PS2, for example. Further, this enables the negotiation execution section 14A to calculate the difference d(ω2)=f2(ω2)−β2 or the ratio r(ω2)=f2(ω2)/β2, using the threshold α2 included in the second negotiation strategy PS2. The difference d(ω2) and the ratio r(ω2) each indicates how much the margin of concession is left on the second negotiation entity side. Thus, for example, when the difference d(ω2) exceeds a predetermined threshold d0 (d0>0) or when the ratio r(ω2) exceeds a predetermined threshold r0 (r0>1), it is determined to “disagree” to the draft agreement candidate ω2; this makes it possible to increase the probability that a consensus forms with the draft agreement candidate ω that has a higher utility value f1(ω).

When determining to “agree” in step S106A, the negotiation apparatus 1A provides an agreement notice to the negotiation apparatus 2 in step S107, and the negotiation apparatus 2 receives the agreement notice from the negotiation apparatus 1A in step S208. Thus, a consensus forms and the negotiation ends.

When determining to “disagree” in step S106A, the negotiation apparatus 1A selects a new draft agreement candidate ω16Q in step S108A. At this time, the negotiation apparatus 1A refers to the first disclosed negotiation strategy PS1 and the second disclosed negotiation strategy PS2 to select the new draft agreement candidate ω1.

For example, the negotiation execution section 14A selects the new draft agreement candidate ω1 in step S108A as follows. First, the negotiation execution section 14A selects, from among the set Ω of draft agreement candidates, one or more draft agreement candidates ω each agreeable to both the first negotiation entity and the second negotiation entity, that is, one or more draft agreement candidates ω with the utility value f1(ω) greater than the threshold β1 and the utility value f2(ω) greater than the threshold α2. When one draft agreement candidate ω is selected, the negotiation execution section 14A sets each element of the one selected draft agreement candidate ω as an agreement expected value corresponding to the element. In contrast, when multiple draft agreement candidates ω are selected, the negotiation execution section 14A sets a mean value of each element of the multiple selected draft agreement candidates ω as an agreement expected value corresponding to the element. For example, when the draft agreement candidate ω includes a product price and a product quantity, this yields an agreement expected value corresponding to the product price and an agreement expected value corresponding to the product quantity. Next, the negotiation execution section 14A refers to the agreement expected values corresponding to respective elements of the one or more selected draft agreement candidates w, and selects a new draft agreement candidate ω1 from among one or more draft agreement candidates each agreeable to the first negotiation entity. For example, as the new draft agreement candidate ω1, the negotiation execution section 14A selects, from among the set of the draft agreement candidates ω having the utility value f1(ω) greater than the threshold β1, a draft agreement candidate ω having the elements each matching the agreement expected value, or a draft agreement candidate ω′ that is best-fitted approximation to the draft agreement candidate ω. It should be noted that when selecting a new draft agreement candidate ω1 as in the foregoing, the second disclosed negotiation strategy PS2 needs to include the threshold α2.

As a typical algorithm for selecting a draft agreement candidate to be presented to a negotiation partner, there is a known algorithm that randomly selects, before negotiation, from among the set Ω, multiple draft agreement candidates (e.g., the number of which may be the same as the maximum number of negotiations) each having the utility value greater than a threshold, and then, during negotiation, presents these draft agreement candidates to the negotiation partner in descending order from the higher utility value. The negotiation execution section 14A may carry out the following process, using this algorithm. That is, the negotiation execution section 14A generates, before negotiation, a first agent that operates in accordance with the algorithm, using the first disclosed negotiation strategy PS1, and a second negotiation agent that operates in accordance with the algorithm, using the second disclosed negotiation strategy PS2. Next, the negotiation execution section 14A executes a virtual negotiation (negotiation simulation) by the first negotiation agent and the second negotiation agent multiple times. Next, the negotiation execution section 14A sets a mean (mean of each element) of draft agreement candidates ω₁ₛₜ, ω_{2nd}, . . . , obtained as a result of the virtual negotiations, as the draft agreement candidate ω′. Next, the negotiation execution section 14A creates a row of the draft agreement candidates ω₁=ω′, ω₂, ω₃, . . . , ωₙ=ω″ (f1(ω₁)<f1(ω₂)< . . . <f1(ωₙ) that starts from the draft agreement candidate ω′ and ends with the draft agreement candidate ω″ that has the highest utility value f1(ω″). It should be noted that ω″ may be a draft agreement candidate with the highest utility value f1(ω″) among the draft agreement candidates ω₁ₛₜ, ω_{2nd}, . . . , resulting from the virtual negotiations, or alternatively, may be a draft agreement candidate with the highest utility value f1(ω″) in the set Ω. The foregoing discusses the process executed by the negotiation execution section 14A before negotiation. Then, the negotiation execution section 14A provides the draft agreement candidates included in the abovementioned row of the draft agreement candidates ω₁, ω₂, ω₃, . . . , ωₙ to the second negotiation entity in descending order of utility value, that is, ωₙ, ωₙ₋₁, . . . , ω₁, during negotiation. For example, in step S108A carried out for the first time, the draft agreement candidate ωₙ is selected as the draft agreement candidate ω₁ to be provided to the second negotiation entity, then, in step S108A carried out for the second time, the draft agreement candidate ωₙ₋₁ is selected as the draft agreement candidate ω₁ to be provided to the second negotiation entity.

Alternatively, the negotiation execution section 14A selects a new draft agreement candidate ω1 in step S108A as follows. That is, as the new draft agreement candidate ω1, the negotiation execution section 14A selects the draft agreement candidate ω that maximizes the sum of utilities brought to the first negotiation entity and the second negotiation entity, from among the set of the draft agreement candidates each agreeable to the first negotiation entity. For example, as the new draft agreement candidate ω1, the negotiation execution section 14A selects a draft agreement candidate ω that maximizes a sum of utility value f1(ω) and utility value f2(ω), that is, f1(ω)+f2(ω), from among the set of draft agreement candidates ω each having the utility value f1(ω) greater than the threshold 1. Here, the algorithm for selecting a draft agreement candidate ω that maximizes the sum of the utility value f1(ω) and the utility value f2(ω), that is, f1(ω)+f2(ω), is not particularly limited, and it may be sufficient to use a combination optimization method, for example. If the set ω of draft agreement candidates cannot be fully searched due to combinatorial explosion, a combinatorial optimization engine such as Simulated Annealing may be used. It should be noted that when selecting a new draft agreement candidate ω1 as in the foregoing, the second disclosed negotiation strategy PS2 is not necessary to include the threshold α2.

Is should be noted that the negotiation execution section 14A may be configured to execute, before negotiation, both the abovementioned process and a process of creating a row of draft agreement candidates ω₁=ω, ω₂, ω₃, . . . , ωₙ=ω″(f1(ω₁)<f1(ω₂) < . . . <f1(ωₙ)) that starts from a draft agreement candidate ω that maximizes the sum of utilities brought to the first negotiation entity and the second negotiation entity, and ends with the draft agreement candidate ω″ that has the highest utility value f1(ω″). In this case, the negotiation execution section 14A provides the draft agreement candidates included in the abovementioned row of the draft agreement candidates ω₁, ω₂, ω₃, . . . , ωₙ to the second negotiation entity in descending order of utility value, that is, ωₙ, ωₙ₋₁, . . . , ω₁, during negotiation. For example, in step S108A carried out for the first time, the draft agreement candidate on is selected as the draft agreement candidate ω₁ to be provided to the second negotiation entity, then, in step S108A carried out for the second time, the draft agreement candidate ωₙ₋₁ is selected as the draft agreement candidate ω₁ to be provided to the second negotiation entity.

Next, in step S101, the negotiation apparatus 1A provides the new draft agreement candidate ω1 to the negotiation apparatus 2. In step S201, the negotiation apparatus 2 receives the new draft agreement candidate ω1 from the negotiation apparatus 1A. When the draft agreement candidate ω2 is referred to as an “offer”, the new draft agreement candidate ω1 may also be referred to as a “counter-offer”.

The negotiation apparatus 1A and the negotiation apparatus 2 repeatedly carry out steps S101 to S108 and steps S201 to S208 until the negotiation apparatus 2 agrees to the draft agreement candidate ω1 in step S203, or until the negotiation apparatus 1A agrees to the draft agreement candidate ω2 in step S106A.

### Example Advantage of Negotiation Apparatus

The present example embodiment enables the first negotiation entity (negotiation apparatus 1A) to determine the draft agreement candidate ω1 to be provided to the second negotiation entity (negotiation apparatus 2) with reference to the second disclosed negotiation strategy PS2. This enables the first negotiation entity (negotiation apparatus 1A) to provide the second negotiation entity (negotiation apparatus 2) with the draft agreement candidate ω1 having a high probability that the second negotiation entity (negotiation apparatus 2) agrees. Therefore, it is possible to reduce the number of times the draft agreement candidate ω1 is provided until a consensus forms.

Therefore, in the setting in which negotiation continues until a consensus forms, it is possible to further shorten the time until the consensus forms. Further, in the setting in which negotiation is terminated when a consensus does not form within a predetermined time, the probability that no consensus forms can be further reduced. In addition, in the settings in which a forced agreement is made with the last draft agreement candidate provided when no consensus forms within a predetermined time, it is possible to further reduce the probability that it is forced to reach an agreement before the utility value increases to a sufficiently high value.

### Third Example Embodiment

The following description will discuss a third example embodiment of the present invention with reference to the drawings. The same reference numerals are given to constituent elements which have functions identical to those described in the first and second example embodiments, and descriptions as to such constituent elements are omitted.

### (Configuration of Negotiation Apparatus)

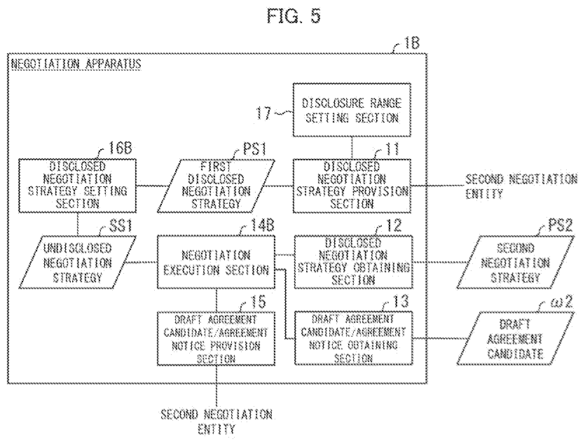

The following description will discuss the configuration of a negotiation apparatus 1B in accordance with the present example embodiment with reference to FIG. 5. FIG. 5 is a block diagram illustrating the configuration of the negotiation apparatus 1B.

As illustrated in FIG. 5, the negotiation apparatus 1B includes: a disclosed negotiation strategy provision section 11; a disclosed negotiation strategy obtaining section 12; a draft agreement candidate/agreement notice obtaining section 13; a negotiation execution section 14B; and a draft agreement candidate/agreement notice provision section 15.

The disclosed negotiation strategy provision section 11 is means for providing a first disclosed negotiation strategy PS1, similarly to the disclosed negotiation strategy provision section 11 included in the negotiation apparatus 1. The disclosed negotiation strategy obtaining section 12 is means for obtaining a second disclosed negotiation strategy PS2, similarly to the disclosed negotiation strategy obtaining section 12 included in the negotiation apparatus 1A. The draft agreement candidate/agreement notice obtaining section 13 is means for obtaining a draft agreement candidate ω2 or an agreement notice, similarly to the draft agreement candidate/agreement notice obtaining section 13 included in the negotiation apparatus 1A. The draft agreement candidate/agreement notice provision section 15 is means for providing a draft agreement candidate ω2 or an agreement notice, similarly to the draft agreement candidate/agreement notice provision section 15 included in the negotiation apparatus 1A.

The negotiation execution section 14B is means for (1) determining, with reference to an undisclosed negotiation strategy SS1, as to whether or not to agree to the draft agreement candidate ω2; and then (2) when it is determined to “disagree” to the draft agreement candidate ω2, selecting a new draft agreement candidate ω1 with reference to the undisclosed negotiation strategy SS1 and the second disclosed negotiation strategy PS2. The negotiation execution section 14B may refer to the second disclosed negotiation strategy PS2 in addition to the undisclosed negotiation strategy SS1 in determining whether or not to agree to the draft agreement candidate ω2. In addition, when a plurality of negotiation strategies are available as the undisclosed negotiation strategy SS1, the negotiation execution section 14B may be configured to switch the negotiation strategy referred to as the undisclosed negotiation strategy SS1 in the above determination and selection, in accordance with the draft agreement candidate ω2. For example, depending on whether or not the draft agreement candidate ω2 is highly likely to receive an order, it is conceivable to switch a negotiation strategy referred to as the undisclosed negotiation strategy SS1 in the abovementioned determination and selection.

The undisclosed negotiation strategy SS1 is an undisclosed negotiation strategy of the first negotiation entity and includes a third utility function f3 or a parameter set defining the third utility function f3. The third utility function f3 is assumed to be, for example, the function f1: Ω→R in which a set Ω of draft agreement candidates is used as a domain and a set R of real numbers is used as a range. In this case, utility value f3(ω) in connection with each draft agreement candidate ω represents, for example, a utility or benefit brought to the first negotiation entity when a consensus forms with the draft agreement candidate ω. For a draft agreement candidate ω obtained from the second negotiation entity, the first negotiation entity agrees to the draft agreement candidate ω when the utility value f3(ω) exceeds a predetermined threshold α3, for example. For a draft agreement candidate ω to be provided to the second negotiation entity, the first negotiation entity selects the draft agreement candidate ω when the utility value f3(ω) exceeds a predetermined threshold 3 (which may be β3=α3), for example. The third utility function f3 can be, for example, a trained model that receives a draft agreement candidate ω as input and outputs the utility value f3(ω), that is, an AI. Alternatively, a table that associates a draft agreement candidate ω and the utility value f3(ω) may be used as the third utility function f3. Note that the undisclosed negotiation strategy SS1 may include one or both of the threshold α3 and the threshold β3, in addition to the third utility function f3 or the parameter defining the third utility function f3.

The negotiation apparatus 1B may further include a negotiation strategy setting section 16B. The negotiation strategy setting section 16B is means for setting one or both of the first disclosed negotiation strategy PS1 and the undisclosed negotiation strategy SS1 in accordance with a user operation. When the negotiation apparatus 1B further includes the negotiation strategy setting section 16B, the user of the negotiation apparatus 1B (the first negotiation entity) can freely set one or both of the first disclosed negotiation strategy PS1 and the undisclosed negotiation strategy SS1.

The negotiation apparatus 1B may further include a disclosure range setting section 17. The disclosure range setting section 17 is means for setting the disclosure range of the first disclosed negotiation strategy PS1 in accordance with a user operation, similarly to the disclosure range setting section 17 included in the negotiation apparatus 1A. When the negotiation apparatus 1B further includes the disclosure range setting section 17, the user of the negotiation apparatus 1B (the first negotiation entity) can freely set the disclosure range of the first disclosed negotiation strategy PS1.

### (Operation of Negotiation Apparatus)

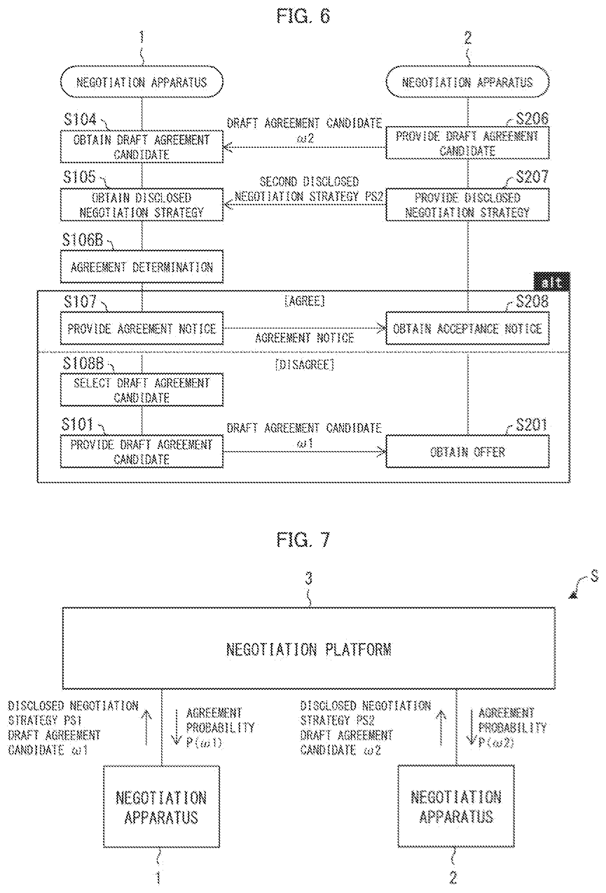

The following description will discuss the operation of the negotiation apparatus 1B with reference to FIG. 6. FIG. 6 is a sequence chart illustrating the flow of the operation of the negotiation apparatus 1B. The negotiation apparatus 1B repeats the operation illustrated in FIG. 2 and the operation illustrated in FIG. 6 until an agreement is reached with the negotiation apparatus 2. Step S104 and step S206 in FIG. 6 correspond to step S104 and step S206 in FIG. 2, respectively. Step S101 and step S201 in FIG. 6 correspond to step S101 and step S201 in FIG. 2, respectively.

The operation of the negotiation apparatus 1B illustrated in FIG. 6 is similar to the operation of the negotiation apparatus 1A illustrated in FIG. 4, but differs in that step 106A is replaced with step S106B and step 108A is replaced with step S108B. Therefore, the following description will discuss step S106B and step S108B.

Next, in step S106B, the negotiation apparatus 1B determines whether or not to agree to the draft agreement candidate ω2. At this time, the negotiation apparatus 1B refers to the undisclosed negotiation strategy SS to determine whether or not to agree to the draft agreement candidate ω2.

For example, in step S106B, the negotiation execution section 14B determines whether or not to agree to the draft agreement candidate ω2 as follows. First, the negotiation execution section 14A calculates the utility value f3(ω2) of the draft agreement candidate ω2, using the third utility function f3 included in the undisclosed negotiation strategy SS. Next, the negotiation execution section 14B compares the utility value f3(ω2) of the draft agreement candidate ω2 with the threshold α3. Then, the negotiation execution section 14B determines to “agree” to the draft agreement candidate ω2 when the utility value f3(ω2) of the draft agreement candidate ω2 exceeds the threshold α3, and otherwise, the negotiation execution section 14B determines to “disagree” to the draft agreement candidate ω2. The negotiation execution section 14B may refer to the second disclosed negotiation strategy PS2 in addition to the undisclosed negotiation strategy SS to determine whether or not to agree to the draft agreement candidate ω2, similarly to the negotiation execution section 14A included in the negotiation apparatus 1A.

The negotiation execution section 14B may compare the utility value f3(ω2) of the draft agreement candidate ω2 with the utility value f3(ω1) of the draft agreement candidate ω1 scheduled to be provided to the second negotiation entity next, instead of comparing the utility value f3(ω2) of the draft agreement candidate ω2 with the threshold α3. In this case, the negotiation execution section 14B determines to “agree” to the draft agreement candidate ω2 when the utility value f3(ω2) of the draft agreement candidate ω2 exceeds the utility value f3(ω1), and otherwise, the negotiation execution section 14B determines to “disagree” to the draft agreement candidate ω2.

When determining to “disagree” in step S106B, the negotiation apparatus 1B selects a new draft agreement candidate ω1∈Ω in step S108B. At this time, the negotiation apparatus 1B refers to the undisclosed negotiation strategy SS and the second disclosed negotiation strategy PS2 to select the new draft agreement candidate ω1.

For example, the negotiation execution section 14B selects the new draft agreement candidate ω1 in step S108B as follows. First, the negotiation execution section 14B selects, from among the set Ω of draft agreement candidates, one or more draft agreement candidates ω each agreeable to both the first negotiation entity and the second negotiation entity, that is, one or more draft agreement candidates ω with the utility value f3(ω) greater than the threshold β3 and the utility value f2(ω) greater than the threshold α2. When one draft agreement candidate ω is selected, the negotiation execution section 14B sets each element of the one selected draft agreement candidate ω as an agreement expected value corresponding to the element. In contrast, when multiple draft agreement candidates ω are selected, the negotiation execution section 14B sets a mean value of each element of the multiple selected draft agreement candidates ω as an agreement expected value corresponding to the element. For example, when the draft agreement candidate ω includes a product price and a product quantity, this yields an agreement expected value corresponding to the product price and an agreement expected value corresponding to the product quantity. Next, the negotiation execution section 14B refers to the agreement expected values corresponding to respective elements of the one or more selected draft agreement candidates ω, and selects a new draft agreement candidate ω1 from among one or more draft agreement candidates each agreeable to the first negotiation entity. For example, as the new draft agreement candidate ω1, the negotiation execution section 14B selects, from among the set of the draft agreement candidates ω having the utility value f1(ω) greater than the threshold β1, a draft agreement candidate ω having the elements each matching the agreement expected value, or a draft agreement candidate ω′ that is best-fitted approximation to the draft agreement candidate ω. It should be noted that when selecting a new draft agreement candidate ω1 as in the foregoing, the second disclosed negotiation strategy PS2 needs to include the threshold α2.

As a typical algorithm for selecting a draft agreement candidate to be presented to a negotiation partner, an algorithm that randomly selects, before negotiation, from among the set Ω, multiple draft agreement candidates (e.g., the number of which may be the same as the maximum number of negotiations) each having the utility value greater than a threshold, and then, during negotiation, presents these draft agreement candidates to the negotiation partner in descending order from the higher utility value. The negotiation execution section 14B may carry out the following process, using this algorithm. That is, the negotiation execution section 14B generates, before negotiation, a first agent that operates in accordance with the algorithm, using the undisclosed negotiation strategy SS1, and a second negotiation agent that operates in accordance with the algorithm, using the second disclosed negotiation strategy PS2. Next, the negotiation execution section 14B executes a virtual negotiation (negotiation simulation) by the first negotiation agent and the second negotiation agent multiple times. Next, the negotiation execution section 14B sets a mean (mean of each element) of draft agreement candidates ω₁ₛₜ, ω_{2nd}, . . . , obtained as a result of the virtual negotiations, as the draft agreement candidate ω′. Next, the negotiation execution section 14B creates a row of the draft agreement candidates ω₁=ω′, ω₂, ω₃, . . . , ωₙ=ω″ (f1(ω₁)<f1(ω₂)< . . . <f1(ωₙ)) that starts from the draft agreement candidate ω′ and ends with the draft agreement candidate ω″ that has the highest utility value f1(ω″). It should be noted that ω″ may be a draft agreement candidate with the highest utility value f1(ω″) among the draft agreement candidates ω₁ₛₜ, ω_{2nd}, . . . , resulting from the virtual negotiations, or alternatively, may be a draft agreement candidate with the highest utility value f1(ω″) in the set Ω. The foregoing discusses the process executed by the negotiation execution section 14B before negotiation. Then, the negotiation execution section 14B provides the draft agreement candidates included in the abovementioned row of the draft agreement candidates ω₁, ω₂, ω₃, . . . , ωₙ to the second negotiation entity in descending order of utility value, that is, ωₙ, ωₙ₋₁, . . . , ω₁, during negotiation. Thus, in step S108B carried out for the first time, the draft agreement candidate ωₙ is selected as the draft agreement candidate ω1 to be provided to the second negotiation entity, then, in step S108B carried out for the second time, the draft agreement candidate ωₙ₋₁ is selected as the draft agreement candidate ω1 to be provided to the second negotiation entity.

Alternatively, the negotiation execution section 14B selects a new draft agreement candidate ω1 in step S108B as follows. That is, as the new draft agreement candidate ω1, the negotiation execution section 14B selects the draft agreement candidate ω that maximizes the sum of utilities brought to the first negotiation entity and the second negotiation entity, from among the set of the draft agreement candidates each agreeable to the first negotiation entity. For example, as the new draft agreement candidate ω1, the negotiation execution section 14B selects a draft agreement candidate ω that maximizes a sum of utility value f3(ω) and utility value f2(ω), that is, f3(ω)+f2(ω), from among the set of draft agreement candidates ω each having the utility value f3(ω) greater than the threshold β3. Here, the algorithm for selecting a draft agreement candidate ω that maximizes the sum of the utility value f3(ω) and the utility value f2(ω), that is, f3(ω)+f2(ω), is not particularly limited, and it may be sufficient to use a combination optimization method, for example. If the set w of draft agreement candidates cannot be fully searched due to combinatorial explosion, a combinatorial optimization engine such as Simulated Annealing may be used.

Is should be noted that the negotiation execution section 14B may be configured to execute, before negotiation, both the abovementioned process and a process of creating a row of draft agreement candidates ω₁=ω, ω₂, ω₃, . . . , ωₙ=ω″ (f3(ω₁)<f3(ω₂) < . . . <f3(ωₙ)) that starts from a draft agreement candidate ω that maximizes the sum of utilities brought to the first negotiation entity and the second negotiation entity, and ends with the draft agreement candidate ω″ that has the highest utility value f1(ω″). In this case, the negotiation execution section 14B provides the draft agreement candidates included in the abovementioned row of the draft agreement candidates ω₁, ω₂, ω₃, . . . , ωₙ to the second negotiation entity in descending order of utility value, that is, ωₙ, ωₙ₋₁, . . . , ω₁, during negotiation. For example, in step S108B carried out for the first time, the draft agreement candidate on is selected as the draft agreement candidate ω₁ to be provided to the second negotiation entity, then, in step S108B carried out for the second time, the draft agreement candidate ωₙ₋₁ is selected as the draft agreement candidate ω₁ to be provided to the second negotiation entity.

### Example Advantage of Negotiation Apparatus

The present example embodiment enables the first negotiation entity (negotiation apparatus 1A) to determine the draft agreement candidate ω1 to be provided to the second negotiation entity (negotiation apparatus 2) with reference to the second disclosed negotiation strategy PS2. This enables the first negotiation entity (negotiation apparatus 1A) to provide the second negotiation entity (negotiation apparatus 2) with the draft agreement candidate ω1 having a high probability that the second negotiation entity (negotiation apparatus 2) agrees. Therefore, it is possible to reduce the number of times the draft agreement candidate ω1 is provided until a consensus forms.

Therefore, in the setting in which negotiation continues until a consensus forms, it is possible to further shorten the time until the consensus forms. Further, in the setting in which negotiation is terminated when a consensus does not form within a predetermined time, the probability that no consensus forms can be further reduced. In addition, in the settings in which a forced agreement is made with the last draft agreement candidate provided when no consensus forms within a predetermined time, it is possible to further reduce the probability that it is forced to reach an agreement before the utility value increases to a sufficiently high value.

### Fourth Example Embodiment

The following description will discuss a negotiation system S in accordance with a fourth example embodiment of the present invention with reference to FIG. 7. FIG. 7 is a block diagram illustrating the configuration of the negotiation system S.

The negotiation system S is constituted by a negotiation apparatus 1, a negotiation apparatus 2, and a negotiation platform 3, as illustrated in FIG. 7.

The negotiation apparatus 1 has a function of providing the first disclosed negotiation strategy PS1 to the negotiation platform 3, as described in the first example embodiment. In addition, the negotiation apparatus 1 has a function of providing the draft agreement candidate ω1 to the negotiation platform 3, and a function of obtaining an agreement probability P(ω1) regarding the draft agreement candidate ω1 from the negotiation platform 3.

The negotiation apparatus 2 has a function of providing the second disclosed negotiation strategy PS2 to the negotiation platform 3, as described in the first example embodiment. In addition, the negotiation apparatus 2 has a function of providing the draft agreement candidate ω2 to the negotiation platform 3, and a function of obtaining an agreement probability P(ω2) regarding the draft agreement candidate ω2 from the negotiation platform.

The negotiation platform 3 has the following functions: (1) function of referring to the first disclosed negotiation strategy PS1 and the second disclosed negotiation strategy PS2 to calculate the agreement probability P(ω1) regarding the draft agreement candidate ω1 when the draft agreement candidate ω1 is obtained from the negotiation apparatus 1; and (2) function of providing the calculated agreement probability P(ω1) to the negotiation apparatus 1. Further, the negotiation platform 3 has the following functions: (1) function of referring to the first disclosed negotiation strategy PS1 and the second disclosed negotiation strategy PS2 to calculate the agreement probability P(ω2) regarding the draft agreement candidate ω2 when the draft agreement candidate ω2 is obtained from the negotiation apparatus 2; and (2) function of providing the calculated agreement probability P(ω1) to the negotiation apparatus 1.

The negotiation apparatus 1 presents the draft agreement candidate ω1 to the negotiation apparatus 2 when the agreement probability P(ω1) obtained from the negotiation platform 3 is sufficiently high (e.g., greater than a predetermined threshold). This enables the negotiation apparatus 1 to provide the negotiation apparatus 2 with the draft agreement candidate ω1 having a high probability that the negotiation apparatus 2 agrees. Similarly, the negotiation apparatus 2 presents the draft agreement candidate ω2 to the negotiation apparatus 1 when the agreement probability P(ω2) obtained from the negotiation platform 3 is sufficiently high (e.g., greater than a predetermined threshold). This enables the negotiation apparatus 2 to provide the negotiation apparatus 2 with the draft agreement candidate ω2 having a high probability that the negotiation apparatus 1 agrees.

### Software Implementation Example

The functions of part of or all of the negotiation apparatuses 1, 1A, and 1B can be realized by hardware such as an integrated circuit (IC chip) or can be alternatively realized by software.

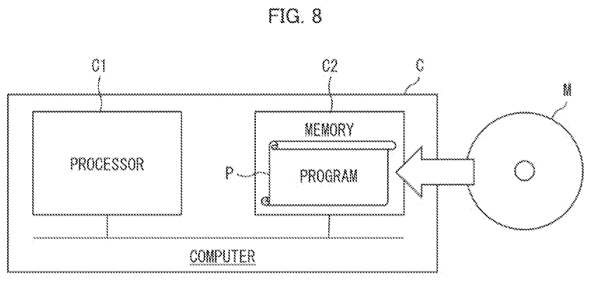

In the latter case, the negotiation apparatuses 1, 1A, and 1B are implemented by, for example, a computer that executes instructions of a program that is software implementing the foregoing functions. FIG. 8 illustrates an example of such a computer (hereinafter, referred to as “computer C”). The computer C includes at least one processor C1 and at least one memory C2. The memory C2 stores a program P for causing the computer C to function as the negotiation apparatuses 1, 1A, and 1B. The processor C1 of the computer C retrieves the program P from the memory C2 and executes the program P, so that the functions of the negotiation apparatuses 1, 1A, and 1B are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the above example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some of or all of the foregoing example embodiments can also be described as below. Note, however, that the present invention is not limited to the following supplementary notes.

### (Supplementary Note 1)

A negotiation apparatus including disclosed negotiation strategy provision means for providing a first disclosed negotiation strategy that is a disclosed negotiation strategy of a first negotiation entity and that includes a first utility function or a parameter set defining the first utility function.

### (Supplementary Note 2)

The negotiation apparatus according to Supplementary note 1, further including:
disclosed negotiation strategy obtaining means for obtaining a second disclosed negotiation strategy that is a disclosed negotiation strategy of a second negotiation entity and that includes a second utility function or a parameter set defining the second utility function; and
negotiation execution means for referring to the first disclosed negotiation strategy and the second disclosed negotiation strategy, to select a draft agreement candidate to be provided to the second negotiation entity.

### (Supplementary Note 3)

The negotiation apparatus according to Supplementary note 2, wherein the negotiation execution means (1) refers to the first disclosed negotiation strategy and the second disclosed negotiation strategy, to select one or more draft agreement candidates each agreeable to both the first negotiation entity and the second negotiation entity, and (2) refers to agreement expected values corresponding to respective elements of the one or more selected draft agreement candidates, to select a draft agreement candidate to be provided to the second negotiation entity.

### (Supplementary Note 4)

The negotiation apparatus according to Supplementary note 2, wherein the negotiation execution means refers to the first disclosed negotiation strategy and the second disclosed negotiation strategy, to select a draft agreement candidate to be provided to the second negotiation entity such that a sum total of utilities brought to the first negotiation entity and the second negotiation entity is maximized.

### (Supplementary Note 5)

The negotiation apparatus according to any one of

Supplementary notes 2 to 4, further including negotiation strategy setting means for setting the first disclosed negotiation strategy in accordance with a user operation.

### (Supplementary Note 6)

The negotiation apparatus according to Supplementary note 1, further including:
disclosed negotiation strategy obtaining means for obtaining a second disclosed negotiation strategy that is a disclosed negotiation strategy of a second negotiation entity and that includes a second utility function or a parameter set defining the second utility function; and
negotiation execution means for referring to an undisclosed negotiation strategy that is an undisclosed negotiation strategy of the first negotiation entity and that includes a third utility function or a parameter set defining the third utility function and to the second disclosed negotiation strategy, to select a draft agreement candidate to be provided to the second negotiation entity.

### (Supplementary Note 7)

The negotiation apparatus according to Supplementary note 6, wherein the negotiation execution means (1) refers to the undisclosed negotiation strategy and the second disclosed negotiation strategy, to select one or more draft agreement candidates each agreeable to both the first negotiation entity and the second negotiation entity, and (2) refers to agreement expected values corresponding to respective elements of the one or more selected draft agreement candidates, to select a draft agreement candidate to be provided to the second negotiation entity.

### (Supplementary Note 8)

The negotiation apparatus according to Supplementary note 2, wherein the negotiation execution means refers to the undisclosed negotiation strategy and the second disclosed negotiation strategy, to select a draft agreement candidate to be provided to the second negotiation entity such that a sum total of utilities brought to the first negotiation entity and the second negotiation entity is maximized.

### (Supplementary Note 9)

The negotiation apparatus according to any one of Supplementary notes 6 to 8, further including negotiation strategy setting means for setting, in accordance with a user operation, one of the first disclosed negotiation strategy and the undisclosed negotiation strategy, or each of both the first disclosed negotiation strategy and the undisclosed negotiation strategy.

### (Supplementary Note 10)

The negotiation apparatus according to any one of Supplementary notes 1 to 9, further including disclosure range setting means for setting a disclosure range of the first disclosed negotiation strategy in accordance with a user operation.

### (Supplementary Note 11)

A negotiation method including providing, by a computer, a first disclosed negotiation strategy that is a disclosed negotiation strategy of a first negotiation entity and that includes a first utility function or a parameter set defining the first utility function.

### (Supplementary Note 12)

A program causing a computer to function as disclosed negotiation strategy provision means for providing a first disclosed negotiation strategy that is a disclosed negotiation strategy of a first negotiation entity and that includes a first utility function or a parameter set defining the first utility function.

### (Supplementary Note 13)

The negotiation apparatus according to any one of Supplementary notes 2 to 5, wherein a plurality of disclosed negotiation strategies are available as the first disclosed negotiation strategy, and the negotiation execution means switches the disclosed negotiation strategy referred to to select a draft agreement candidate to be provided to the second negotiation entity, in accordance with a draft agreement candidate obtained from the second negotiation entity.

### (Supplementary Note 14)

The negotiation apparatus according to any one of Supplementary notes 6 to 9, wherein a plurality of disclosed negotiation strategies are available as the undisclosed negotiation strategy, and the negotiation execution means switches the disclosed negotiation strategy referred to to select a draft agreement candidate to be provided to the second negotiation entity, in accordance with a draft agreement candidate obtained from the second negotiation entity.

### (Supplementary Note 15)

The negotiation apparatus according to any one of Supplementary notes 1 to 10, 13, and 14, having a function of providing, to a negotiation platform, a draft agreement candidate to be provided to the second negotiation entity and a function of obtaining, from the negotiation platform, an agreement probability regarding the draft agreement candidate, wherein the disclosed negotiation strategy provision means provides the first disclosed negotiation strategy to the negotiation platform.

### [Additional Remark 3]

Furthermore, some of or all of the above example embodiments can also be expressed as below.

A negotiation apparatus including at least one processor, the at least one processor carrying out a disclosed negotiation strategy provision process of providing a first disclosed negotiation strategy that is a disclosed negotiation strategy of a first negotiation entity and that includes a first utility function or a parameter set defining the first utility function.

Note that the negotiation apparatus may further include a memory, which may store therein a program for causing the at least one processor to carry out the disclosed negotiation strategy provision process. Alternatively, the program may be stored in a non-transitory, tangible computer-readable storage medium.

### REFERENCE SIGNS LIST

1, 1A, 1B Negotiation apparatus
11 Disclosed negotiation strategy provision section
12 Disclosed negotiation strategy obtaining section
13 Draft agreement candidate/agreement notice obtaining section
14A, 14B Negotiation execution section
15 Draft agreement candidate/agreement notice provision section
16A, 16B Disclosed negotiation strategy setting section
17 Disclosure range setting section
PS1 First disclosed negotiation strategy
PS2 Second disclosed negotiation strategy
SS1 Undisclosed negotiation strategy

What is claimed is:

1. A negotiation apparatus comprising at least one processor, the at least one processor carrying out a disclosed negotiation strategy provision process of providing a first disclosed negotiation strategy that is a disclosed negotiation strategy of a first negotiation entity and that includes a first utility function or a parameter set defining the first utility function.

2. The negotiation apparatus according to claim 1, wherein the at least one processor further carries out:
a disclosed negotiation strategy obtaining process of obtaining a second disclosed negotiation strategy that is a disclosed negotiation strategy of a second negotiation entity and that includes a second utility function or a parameter set defining the second utility function; and
a negotiation execution process of referring to the first disclosed negotiation strategy and the second disclosed negotiation strategy, to select a draft agreement candidate to be provided to the second negotiation entity.

3. The negotiation apparatus according to claim 2, wherein, in the negotiation execution process, the at least one processor (1) refers to the first disclosed negotiation strategy and the second disclosed negotiation strategy, to select one or more draft agreement candidates each agreeable to both the first negotiation entity and the second negotiation entity, and (2) refers to the one or more selected draft agreement candidates, to select a draft agreement candidate to be provided to the second negotiation entity.

4. The negotiation apparatus according to claim 2, wherein, in the negotiation execution process, the at least one processor (1) refers to the first disclosed negotiation strategy and the second disclosed negotiation strategy, to select a draft agreement candidate that maximizes a sum total of utilities brought to the first negotiation entity and the second negotiation entity, and (2) refers to the selected draft agreement candidate, to select a draft agreement candidate to be provided to the second negotiation entity.

5. The negotiation apparatus according to claim 2, wherein the at least one processor further carries out a negotiation strategy setting process of setting the first disclosed negotiation strategy in accordance with a user operation.

6. The negotiation apparatus according to claim 1, wherein the at least one processor further carries out:
a disclosed negotiation strategy obtaining process of obtaining a second disclosed negotiation strategy that is a disclosed negotiation strategy of a second negotiation entity and that includes a second utility function or a parameter set defining the second utility function; and
a negotiation execution process of referring to an undisclosed negotiation strategy that is an undisclosed negotiation strategy of the first negotiation entity and that includes a third utility function or a parameter set defining the third utility function and to the second disclosed negotiation strategy, to select a draft agreement candidate to be provided to the second negotiation entity.

7. The negotiation apparatus according to claim 6, wherein, in the negotiation execution process, the at least one processor (1) refers to the undisclosed negotiation strategy and the second disclosed negotiation strategy, to select one or more draft agreement candidates each agreeable to both the first negotiation entity and the second negotiation entity, and (2) refers to the one or more selected draft agreement candidates, to select a draft agreement candidate to be provided to the second negotiation entity.

8. The negotiation apparatus according to claim 6, wherein, in the negotiation execution process, the at least one processor (1) refers to the undisclosed negotiation strategy and the second disclosed negotiation strategy, to select a draft agreement candidate that maximizes a sum total of utilities brought to the first negotiation entity and the second negotiation entity, and (2) refers to the selected draft agreement candidate, to select a draft agreement candidate to be provided to the second negotiation entity.

9. The negotiation apparatus according to claim 6, wherein the at least one processor further carries out a negotiation strategy setting process of setting, in accordance with a user operation, one of the first disclosed negotiation strategy and the undisclosed negotiation strategy, or each of both the first disclosed negotiation strategy and the undisclosed negotiation strategy.

10. The negotiation apparatus according to claim 1, wherein the at least one processor further carries out a disclosure range setting process of setting a disclosure range of the first disclosed negotiation strategy in accordance with a user operation.

11. A negotiation method comprising providing, by a computer, a first disclosed negotiation strategy that is a disclosed negotiation strategy of a first negotiation entity and that includes a first utility function or a parameter set defining the first utility function.

12. A computer-readable non-transitory storage medium storing a negotiation program causing a computer to carry out a negotiation strategy provision process of providing a first disclosed negotiation strategy that is a disclosed negotiation strategy of a first negotiation entity and that includes a first utility function or a parameter set defining the first utility function.
